(19) United States
(12) Patent Application Publication
(10) Pub. No.: US 2021/0364333 A1
(43) Pub. Date: Nov. 25, 2021

(54) PRESSURE-INSENSITIVE THERMAL TYPE FLOW METER

(71) Applicant: BERKIN B.V., RUURLO (NL)

(72) Inventors: Rob HAGELSTEIN, RUURLO (NL); Goijert Lambertus HEIJNEN, RUURLO (NL); Jeroen Wouter BOS, RUURLO (NL); Stefan VON KANN, RUURLO (NL)

(21) Appl. No.: 16/972,953

(22) PCT Filed: Jun. 6, 2019
(86) PCT No.: PCT/NL2019/050340

§ 371 Date: Dec. 7, 2020

(30) Foreign Application Priority Data
Jun. 8, 2018 (NL) 2021082

(51) Int. Cl. G01F 1/69; G01F 5/00

(52) U.S. Cl. CPC G01F 1/69; G01F 5/00

(57) ABSTRACT

The invention relates to a thermal type flow meter, comprising a flow tube for a medium whose flow is to be determined, a sensor tube, having an inlet and an outlet connected to the flow tube, the sensor tube comprising a thermal flow sensor for measuring a temperature differential to determine the flow, a pressure sensor provided at the flow tube to measure the pressure of the flow, a temperature sensor provided at the flow tube to measure the temperature of the flow, characterized by a processing unit for determination of the actual medium properties based on the pressure measured by the pressure sensor, the temperature measured by the temperature sensor and intrinsic medium data and a processing unit for determination of the flow by compensating the measurement of the thermal flow sensor with the actual medium properties and calibration data.

The invention relates to a thermal type flow meter, comprising a flow tube for a medium whose flow is to be determined, a sensor tube, having an inlet fluidly connected to the flow tube at a first position and an outlet fluidly connected to the flow tube at a second, downstream position, wherein the sensor tube comprises a thermal flow sensor for measuring a temperature differential in the sensor tube in order to determine the flow.

Such thermal type flow meters are known from for example EP 1.867.962. In general, thermal flow sensors are furthermore known from JP-S56 73317 A and WO 2012/057886. Thermal flow meters comprising flow sensors with a sensor tube having a capillary tube make use of the fact that heat transfer from the tube wall to a fluid (gas or liquid) that flows in the tube is a function of the mass flow rate, the difference between the fluid temperature and the wall temperature and the specific heat capacity of the fluid. In mass flow controllers a large variety of flow sensor configurations can be used.

The invention in particular relates to a thermal type flow meter further comprising:
a pressure sensor provided at or near the flow tube, wherein the pressure sensor is fluidly connected to e.g. an entrance of the flow tube, or generally at a position upstream of a sensor tube inlet, to measure the pressure of the flow of the medium through the flow tube, and
a temperature sensor provided at the flow tube to measure the temperature of the flow of the medium through the flow tube.

It is generally known that standard thermal mass flow meters (MFM) or mass flow controllers (MFC) are sensitive to changes or fluctuations in pressure and/or temperature. These instruments are calibrated for specified operating conditions (pressure and temperature). When the operating conditions change, the conversion factors have to be modified. These new conversion factors are normally calculated off-line and loaded into the MFM or MFC.

Currently available, pressure-insensitive MFM/MFC's measure the pressure and temperature and determine the correction factors by using look-up-tables or polynomial fits of medium properties.

US 2017/0115150 A1 for instance discloses a capillary heating type thermal type mass flow meter comprising a sensor configured to detect temperature and pressure of a fluid and a correction means configured to correct a mass flow rate based on said temperature and said pressure, change rates of the mass flow rate of the fluid with respect to temperature and pressure have been previously acquired, and the mass flow rate is corrected based on said temperature and said pressure as well as these change rates.

A problem that occurs with the above measuring methods and systems is that inaccuracies in the measuring signal are still relatively prevalent, the above methods for correcting the signal obtained from the thermal flow sensor are relatively cumbersome. As mentioned above, US 2017/0115150 A1 utilizes previously acquired change rate data to correct the mass flow rate. More specifically, as disclosed in paragraph [0068] of US 2017/0115150 A1, a mass flow rate of a fluid of a different kind from a reference fluid is measured. In order to calculate a mass flow rate of a fluid which has different thermal physical properties (for example, heat capacity, et cetera) from those of a reference fluid with a thermal mass flow meter, an actually measured mass flow rate is corrected according to the thermal physical properties of the fluid.

Therein, a mass flow rate is corrected with a conversion factor (CF) which is an intrinsic correction coefficient previously acquired for different kinds of fluid.

Accordingly, it is an object of the invention to provide a thermal type flow meter as described above and a measuring/correction method wherein inaccuracies in the measuring signal are further minimized, and correcting the signal obtained from the thermal flow sensor is made less cumbersome.

The flow meter according to the present invention thereto is characterized by
a processing unit for determination of the actual medium properties based on the pressure measured by the pressure sensor, the temperature measured by the temperature sensor and intrinsic medium data, wherein the intrinsic medium data is determined from the type of medium or medium mix, and the instrument settings, and
a processing unit for determination of the flow by continuously calculating the actual flow through of the thermal flow sensor with the actual medium properties and calibration data. In a preferred embodiment, the pressure is continuously measured by the pressure sensor, and the temperature is continuously measured by the temperature sensor.

Thus, pressure, temperature and flow signal can be measured real-time and/or continuously and are then transported to the processing unit, which utilizes known algorithms to calculate for instance actual density, viscosity, heat capacity and thermal conductivity, and from that the actual (i.e. corrected/compensated) gas flow.

The temperature difference (ΔT) measured by the thermal flow sensor and the actual medium properties are used to calculate (real-time and/or continuously) the real mass flow, with improved independence from the pressure and temperature.

The above flow meter provides much more accurate flow determination results, due to the flow meter no longer having to rely on correction factors contained in look-up tables or calculated by using polynomial fits, and, furthermore, a flow meter's user no longer has to reload conversion factors into the flow meter, making the flow meter much easier to use. The above flow meter effectively prevents the occurrence of pressure variations (such as occurring with known systems, such as mechanical clocks or gas bottles) and the consequent measurement error, leading to the above thermal type flow meter being effectively pressure-insensitive. In addition, the above thermal type flow meter allows to limit the system when gasses or fluids move towards the vapor pressure line. Furthermore, the above thermal type flow meter allows to calculate valve capacity by using the actual pressure.

Thus, the flow meter according to the invention does not have to use a previously determined correction factor to calculate the mass flow rate, as opposed to the flow meter disclosed in US 2017/0115150 A1. The flow meter according to the present invention continuously measures intrinsic medium data and therefore does not have to use previously stored data. Furthermore, the flow meter according to the present invention preferably measures intrinsic medium data in real time.

Advantageous embodiments form the subject matter of the dependent claims. A few of these embodiments will be explained in more detail hereinafter.

In an embodiment of the flow meter, the actual medium properties comprise actual density, viscosity, heat capacity, thermal conductivity and/or vapour pressure, from which the actual medium properties are to be calculated. The medium may, of course, comprise a fluid, a gas or a liquid.

In an embodiment of the flow meter, the pressure sensor and the temperature sensor are provided at the flow tube downstream of the first position and upstream of the second position.

The intrinsic medium data may comprise molecular mass, critical properties, dipole momentum, and/or boiling point.

Another aspect of the invention relates to a method for determining a flow of a medium by using a thermal type flow meter, comprising the steps of:
flowing a medium through a flow tube of the thermal type flow meter,
flowing the medium through a sensor tube, having an inlet fluidly connected to the flow tube at a first position and an outlet fluidly connected to the flow tube at a second, downstream position,
measuring a temperature differential in the sensor tube using a thermal flow sensor comprised by the sensor tube in order to determine the flow, preferably continuously,
measuring the pressure of the flow of the medium through the flow tube by using a pressure sensor provided at or near the flow tube, preferably continuously,
measuring the temperature of the flow of the medium through the flow tube by using a temperature sensor provided at the flow tube, preferably continuously, characterized by
determining the actual medium properties based on the pressure measured by the pressure sensor, the temperature measured by the temperature sensor and intrinsic medium data, wherein the intrinsic medium data is determined from the type of medium, instrument settings and/or medium mix,
determining the flow by continuously calculating the actual flow through the thermal flow sensor with the actual medium properties and calibration data.

As stated in the foregoing, the flow meter according to the present invention measures intrinsic medium data continuously and/or in real time and therefore does not have to use previously stored data.

In an embodiment of the method, the actual medium properties comprise actual density, viscosity, heat capacity, thermal conductivity and/or vapour pressure.

Preferably, as stated before, the intrinsic medium data comprises molecular mass, critical properties, dipole momentum, and/or boiling point.

The invention will now be explained in more detail with reference to a few preferred embodiments shown in the appended figures.

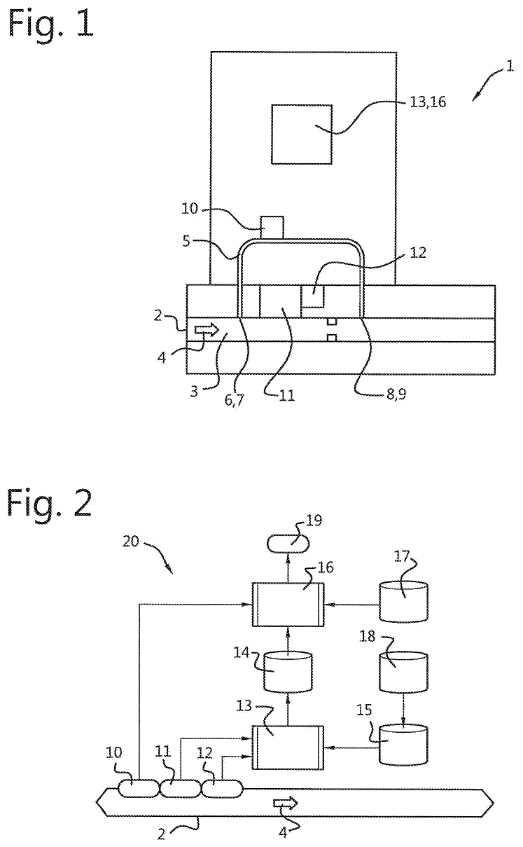

FIG. 1 schematically shows an exemplary embodiment of a thermal type flow meter according to the invention; and

FIG. 2 shows an exemplary embodiment of the method according to the present invention.

FIG. 1 shows a thermal type flow meter 1, comprising a flow tube 2 for a medium 3 whose flow 4 is to be determined. A sensor tube 5 is shown, having an inlet 6 fluidly connected to the flow tube 2 at a first position 7 and an outlet 8 fluidly connected to the flow tube 2 at a second, downstream position 9. The sensor tube 5 comprises a thermal flow sensor 10 for measuring a temperature differential in the sensor tube 5 in order to determine the flow 4. A pressure sensor 11 is provided at or near the flow tube 2 to measure the pressure of the flow 4 of the medium 3 through the flow tube 2. The pressure sensor 11 can be provided near the flow tube 2, wherein the pressure sensor 11 is fluidly connected to the flow tube 2 via a pressure sensing channel (not shown). Preferably, the pressure sensor 11 is arranged for measuring pressure at a position upstream of the sensor tube inlet 6, such as at an entrance of the flow tube 2. Additionally, a temperature sensor 12 is provided at the flow tube 2 to measure the temperature of the flow 4 of the medium 3 through the flow tube 2. The pressure sensor 11 can, of course, also be arranged to measure pressure at other flow tube 2 positions, such as at a position downstream of the sensor tube outlet 8. It is also conceivable that multiple pressure sensors 11 are used for pressure measurements, such as one, two, three or even more. A processing unit 13 is indicated for determination of the actual medium 3 properties 14 based on the pressure measured by the pressure sensor 11, the temperature measured by the temperature sensor 12 and intrinsic medium data 15 (as shown in FIG. 2). A processing unit 16 is also shown for determination of the flow 4 continuously calculating the actual flow through of the thermal flow sensor 10 with the actual medium 3 properties and calibration data 17 (as shown in FIG. 2). Of course, the processing units 13, 16 may be embodied by a single processing unit or CPU. Preferably, the sensor tube 5 and/or the processing units 13, 16 are arranged on a (preferably single) Printed Circuit Board (PCB) comprised by the thermal type flow meter 1. The pressure sensor 11 and temperature sensor 12 are preferably arranged on or attached to the flow tube 2 (preferably not on the PCB).

The intrinsic medium data 15 may be retrieved from a database, such as the normalized fluid database available as part of the Applicant's FLUIDAT® software package. This database comprises 800 fluids, mainly comprising hydrocarbons, complemented with most well-known inorganic fluids, such as air, argon and helium. Essentially, a three-step process is used therein: the identity or type of fluid (i.e. gas, liquid or plasma) is provided as input and combined with sensor data regarding pressure (obtained by means of the pressure sensor 11) and temperature (obtained by means of the temperature sensor 12). This information is then provided as input to a normalized database, such as Applicant's FLUIDAT® database, and more accurate numbers are then calculated for, among others, thermal conductivity, heat capacity, density and viscosity. The previously calculated numbers for thermal conductivity, heat capacity, density and viscosity and the unfiltered signal of the thermal flow sensor 10 are then converted to mass flow rate.

A specific type of construction of the flow meter 1 for example includes the use of a stainless steel sensor tube 5 with two or more resistance elements (not shown) which are in thermally conductive contact with the sensor tube 5. The resistance elements are typically made of a material having a high resistance temperature coefficient. Each of the elements can function as a heater, as a temperature detector, or as both. At least one resistance element (the heater) is energised with electrical current for supplying heat to the sensor tube 5. When two heaters with a constant power are energised, the mass flow rate of the fluid through the sensor tube 5 can be derived from the temperature difference between the resistance elements. This temperature difference is then sensed by a thermal flow sensor 10 to determine the flow.

In another method, a first resistance element at a first position functions as a heater and as a temperature detector, and a second resistance element disposed at a second position, upstream of the first position, functions as a temperature detector.

The actual medium 3 properties may comprise actual density, viscosity, heat capacity, thermal conductivity and/or vapour pressure. The intrinsic medium data 15 is determined from the type of medium/fluid, instrument settings and/or medium/fluid mix 18.

In an advantageous configuration, the pressure sensor 11 and the temperature sensor 12 are provided at the flow tube 2 downstream of the first position 7 and upstream of the second position 9.

The intrinsic medium data 15 as shown comprises molecular mass, critical properties, dipole momentum, boiling point, et cetera.

FIG. 2 schematically shows a method 20 for determining a flow 4 of a medium 3 by using a thermal type flow meter 1, such as described above. The medium 3 is flowed through a flow tube 2 of the thermal type flow meter 1. The medium 3 is also flowed through a sensor tube 5, having an inlet 6 fluidly connected to the flow tube 2 at a first position 7 and an outlet 8 fluidly connected to the flow tube 2 at a second, downstream position 9. A temperature differential is measured in the sensor tube 5 using a thermal flow sensor 10 comprised by the sensor tube 5 in order to determine the flow 4. The pressure of the flow 4 of the medium 3 through the flow tube 2 is measured by using a pressure sensor 11 provided at or near the flow tube 2. In addition, the temperature of the flow 4 of the medium 3 through the flow tube 2 is measured by using a temperature sensor 12 provided at the flow tube 2. The actual medium properties 14 are determined based on the pressure measured by the pressure sensor 11, the temperature measured by the temperature sensor 12 and intrinsic medium data 15. The flow 4 is determined by continuously calculating the actual flow through the thermal flow sensor 10 with the actual medium 3 properties 14 and calibration data 17.

As stated before, the actual medium 3 properties 14 may comprise actual density, viscosity, heat capacity, thermal conductivity and/or vapour pressure. The intrinsic medium data 15 is determined from the type of medium/fluid, instrument settings and/or medium/fluid mix 18. The intrinsic medium data 15 may comprise molecular mass, critical properties, dipole momentum, and/or boiling point.

In practice, the Applicant has perceived an increase in measuring accuracy using the above thermal flow meter and method associated therewith, using the FLUIDAT® software. The accuracy, however, relates to the method used in combination with the actual temperature and pressure, and the type of fluid to be calculated. Most of the methods in FLUIDAT® are optimized for certain classes of fluids and certain ranges of pressure and/or temperature. Therefore, it is hard to give one general value for the accuracy of the FLUIDAT® calculation results.

A classification of the accuracy of some physical properties:
Heat capacity typical <2%, often better than 0.5%,
Density typical <1%, often better than 0.1%,
Thermal conductivity typical <5%, often better than 2%,
Viscosity typical <5%, often better than 2%, and
Vapor pressure typical <2%, in some areas the error is larger.

The skilled person will appreciate that in the foregoing the invention has been described with reference to a few preferred embodiments. The invention is not limited to these embodiments, however. Many modifications are conceivable within the scope of the invention. The scope of the protection is determined by the appended claims.

### LIST OF REFERENCE NUMERALS

1. Thermal type flow meter
2. Flow tube
3. Medium
4. Flow
5. Sensor tube
6. Sensor tube inlet
7. First position
8. Sensor tube outlet
9. Second position
10. Thermal flow sensor
11. Pressure sensor provided at flow tube
12. Temperature sensor provided at flow tube
13. Processing unit for determination of actual medium properties
14. Actual medium properties
15. Intrinsic medium data
16. Processing unit for determination of the flow
17. Calibration data
18. Data concerning type of fluid, instrument settings and/or fluid mix
19. Determined flow
20. Method for determining a flow

1. A thermal type flow meter, comprising:
a flow tube for a medium whose flow is to be determined,
a sensor tube, having an inlet fluidly connected to the flow tube at a first position and an outlet fluidly connected to the flow tube at a second, downstream position, wherein the sensor tube comprises a thermal flow sensor for measuring a temperature differential in the sensor tube in order to determine the flow,
a pressure sensor provided at or near the flow tube to measure the pressure of the flow of the medium through the flow tube,
a temperature sensor provided at the flow tube to measure the temperature of the flow of the medium through the flow tube,
a processing unit for determination of the actual medium properties based on the pressure measured by the pressure sensor, the temperature measured by the temperature sensor and intrinsic medium data, wherein the intrinsic medium data is determined from the type of medium, instrument settings and/or medium mix and
a processing unit for determination of the flow by continuously calculating the actual flow through the thermal flow sensor with the actual medium properties and calibration data.

2. A flow meter according to claim 1, wherein the actual medium properties comprise actual density, viscosity, heat capacity, thermal conductivity and/or vapour pressure.

3. A flow meter according to claim 1, wherein the pressure sensor and the temperature sensor are provided at the flow tube downstream of the first position and upstream of the second position.

4. A flow meter according to claim 1, wherein the intrinsic medium data comprises molecular mass, critical properties, dipole momentum, and/or boiling point.

5. A flow meter according to claim 1, wherein the pressure sensor and the temperature sensor measure continuously.

6. Method for determining a flow of a medium by using a thermal type flow meter, comprising the steps of:
flowing the medium through a flow tube of the thermal type flow meter,
flowing the medium through a sensor tube, having an inlet fluidly connected to the flow tube at a first position and an outlet fluidly connected to the flow tube at a second, downstream position,
measuring a temperature differential in the sensor tube using a thermal flow sensor comprised by the sensor tube in order to determine the flow,
measuring the pressure of the flow of the medium through the flow tube by using a pressure sensor provided at or near the flow tube,
measuring the temperature of the flow of the medium through the flow tube by using a temperature sensor provided at the flow tube,
determining the actual medium properties based on the pressure measured by the pressure sensor, the temperature measured by the temperature sensor and intrinsic medium data, wherein the intrinsic medium data is determined from the type of medium, instrument settings and/or medium mix and
determining the flow by continuously calculating the actual flow through the thermal flow sensor with the actual medium properties and calibration data.

7. A method according to claim 6, wherein the actual medium properties comprise actual density, viscosity, heat capacity, thermal conductivity and/or vapour pressure.

8. A method according to claim 6, wherein the intrinsic medium data comprises molecular mass, critical properties, dipole momentum, and/or boiling point.
